(19) United States
(12) Patent Application Publication
(10) Pub. No.: US 2007/0169174 A1
(43) Pub. Date: Jul. 19, 2007

(54) User authentication for computer systems

(76) Inventors: Richard Critten, Leicester (GB); James Edward Charlesworth, Leicester (GB); Andrew Larter, Leicester (GB); Peter Green, Warwickshire (GB); Tracy John Dale, York (GB)

Correspondence Address: FISH & RICHARDSON, PC, P.O. BOX 1022, MINNEAPOLIS, MN, 55440-1022, US

(21) Appl. No.: 10/510,403

(22) PCT Filed: Apr. 4, 2003
(86) PCT No.: PCT/GB03/01493

§ 371 Date: Feb. 21, 2007

(30) Foreign Application Priority Data
Apr. 5, 2002 (GB) 0207955.6

(51) Int. Cl. H04L 9/32; G06F 15/16

(52) U.S. Cl. 726/3

(57) ABSTRACT

A password is held as part of authentication credentials on a secure media such as a smart card of a secure file. A user presents a PIN number which is different from the card which causes GINA or scripting module to unlock the secure module and extract the password. The password is presented to the operating system or an application to authenticate the user. The password may change without the user being aware of the new password. The GINA or scripting module recognises a change password request or screen and generates a new random password which is passed to the operating system or application and, if authenticated, stored as part of the authentication credentials.

This invention relates to the authentication of users of computer systems including applications running a computer system. It is particularly concerned with the generation and storage of passwords or similar authentication phrases.

It is very common for users of computer systems, be they stand alone terminals or large networks, to have to authenticate themselves before they are permitted access to the system. Typically, the user is required by the operating system to present their authentication credentials to the system. These may consist of a user name, a password and, sometimes, a domain. The operating system will check the credentials offered against stored records and, if they match, grant the user access to the system.

A password may not necessarily be a word in the natural language sense, but is a string of characters that has been pre-selected by the user. It may consist of alphanumerics and other characters.

End-users are well known for selecting insecure passwords as they are easy to remember. Typically they will be dictionary words or a name having a particular significance to the user. If users are forced to use more secure passwords, such as a mixture of upper and lower case letters and non-alphanumeric symbols, they tend to write them down as they cannot remember them. This renders the system less secure and vulnerable to attack from unscrupulous third parties. It can make the system less secure that it would be if simple dictionary/name passwords were used.

Because of these problems, most authentication systems do not require end-users to use complex passwords. Instead they rely on frequent changes of password. The users are required to change passwords at regular intervals, for example every 30 days.

While this approach increases the security of the system, it has the problem that users tend to forget their passwords and can be locked out of the system. A lock-out usually requires the intervention of a system administrator to correct it. This is expensive for the system owner if they have outsourced their system administrator. A cost of £40 per forgotten password is typical. For a large organisation that may have in the order of 50,000 users, the cost of forgotten passwords can be extremely high, running into millions of pounds per year.

There is, therefore, a need for a system which can use stronger, more secure passwords, but which does not require the user to remember complex and difficult combinations of characters.

Numerous approaches to the problem can be found in the art. By way of example, U.S. Pat. No. 5,193,114 of Moseley uses automatic key generation and management to authenticate users presenting smart cards. The encryption key generation and management technique has one or more secret constants programmed into the card and reader. The user enters a password of PIN (Personal Identification Number) and the system checks these and other parameters such as the time of each key depression before deciding whether or not to authenticate the user.

U.S. Pat. No. 5,604,801 assigned to International Business Machines Corporation discloses the use of public/private keys. The private key for a user is held as a smart card. The private key is held in encrypted form in the system server and the smart card generates the private key encrypting key and provides that key to the server.

U.S. Pat. No. 5,742,756 assigned to Microsoft Corporation discloses the use of smart cards which are programmed to signal a reader device prior to performing a security critical operation and to wait for a control signal before performing the operation. The reader has a security key operable by a person. The reader supplies the counter-signal to the card only in response to operation of the security key.

U.S. Pat. No. 5,778,071 assigned to Information Resource Engineering Inc., discloses a portable security device which can uniquely identify a user to a network. The device operates as an electronic token which contains all the cryptographic processing required to protect data using encryption, message authentication or digital signatures. The system is particularly intended for use with personal computers communicating across public telephone networks.

U.S. Pat. No. 5,778,072 assigned to Sun Microsystems Inc., integrates smart card and private key operations with existing encryption services and applications. A key store manager manages user key data and handles key requests. User data including user private keys are stored in user information files for users that do not have smart cards. Users connect to the system. If they have a smart card, private key operations requests are forwarded to the card by the key store manager. Thus, the private keys are not compromised by exposure to the computer system. If the user has no smart card, the private key requests are forwarded to an encryption service.

U.S. Pat. No. 5,796,824 assigned to Fujitsu Limited discloses the storage of encrypted data and a medium personal number on a storage medium. The personal number is unique for each storage medium. Encrypted permission information is also stored. The medium personal number is written in an un-rewritable form which a user computer cannot rewrite.

U.S. Pat. No. 5,809,140 assigned to Bell Communications Research, Inc. is concerned with session key distribution using smart cards. A first host initiates the distribution by transmitting a session identifier to a server. The first host uses a smart card storing a secret key to generate a random bit stream which is transmitted to a second host. The server sends a message to the first host which is generated from the session ID and the server secret key. The second host generates a message which is a function of the secret key on its smart card and the random bit stream and sends it to the first host. The first host then generates a potential session key pair as a function of the two messages and its secret key. If this key pair is accepted, one of the keys is sent to the second host which uses its smart card to generate a validity indication based on the received key and the second message. It then accepts or rejects the session key.

Other examples may be found in U.S. Pat. No. 5,825,882, U.S. Pat. No. 5,850,442, U.S. Pat. No. 5,857,021, U.S. Pat. No. 5,857,024 and U.S. Pat. No. 5,892,900 to which reference is made.

None of the references mentioned above solve the problem of how to increase security through use of stronger passwords while not requiring the user to remember difficult and complex passwords.

The invention is defined by the independent claims to which reference should be made.

Embodiments of the invention store a password as part of authentication criteria on a secure media such as a smart card or a secure file. When accessing a computer the user enters an identification such as a PIN. This identification enables the secure media to be opened and the password extracted. The password can be presented for authentication of the user.

Embodiments of the invention have the advantage that a complex password may be stored which is unknown to the user, giving a high degree of security. However, the user is only required to remember a simple PIN which greatly reduces the likelihood of the user forgetting the PIN. This may greatly reduce the cost of replacing forgotten passwords.

Preferably the password can be changed, preferably by generating a new random password in response to a change password request. This request may come from the operating system where the user is being authenticated to the system, or from an application if the user is being authentication to an application. In either case the user may initiate the password change. The system detects the password change request and generates the new random password. This is presented for authorisation and, when accepted, stored as part of the authentication criteria. This has the advantage that passwords may be changed without the user knowing the new password. Again, all the user has to remember is the original PIN. Applications or operating systems may be configured to request password changes at regular intervals, for example every time the user logs on or calls an application. This is transparent to the user and greatly increases security.

In one embodiment, a Graphical Identification and Authentication Module (GINA) is used to unlock the secure media, present the authentication credentials to the operating system in the form of a logon procedure and generate a new password. If the logon procedure authenticates the new password the GINA causes the password to be stored as part of the authentication credentials in the secure medium.

In another preferred embodiment a scripting module is used to authenticate a user to an application. The scripting module provides the password from the storage media to the application. Scripts are generated corresponding to password change screens and the module. On identification of a password change screen generates a new, preferably random password and populates the screen with the new password. If required by the application the screen may also be populated with the old password. The scripting module temporarily stores the new password and when the new password is authenticated causes the secure media to store the new password as part of the authentication credentials.

An embodiment of the invention will now be described, by way of example only, and with reference to the accompanying drawings, in which:

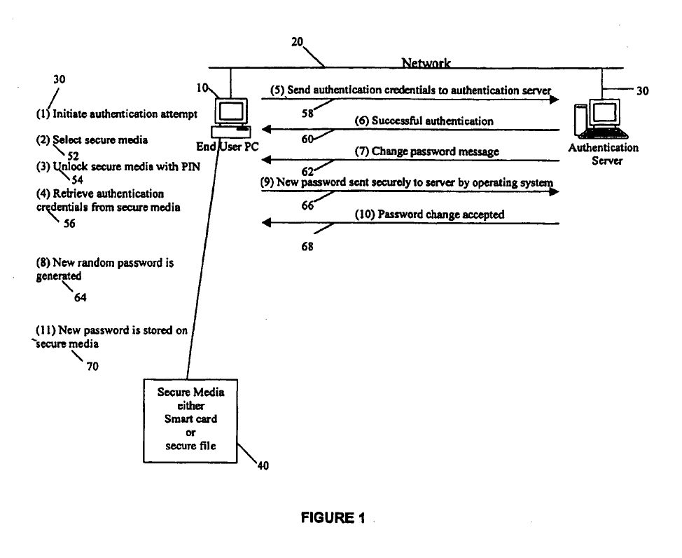

FIG. 1 is an overview of a process and system embodying the invention;

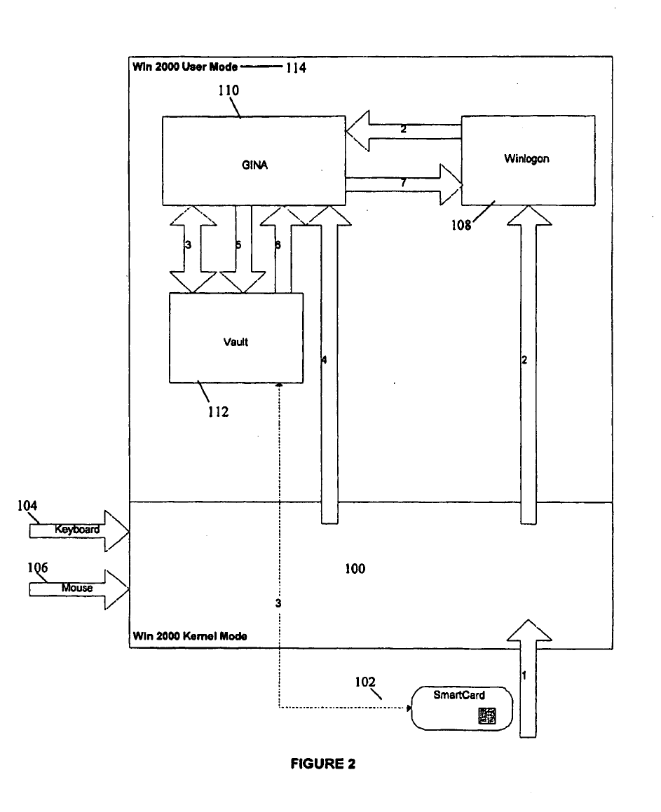

FIG. 2 is a schematic diagram of a smart card authentication system embodying the invention;

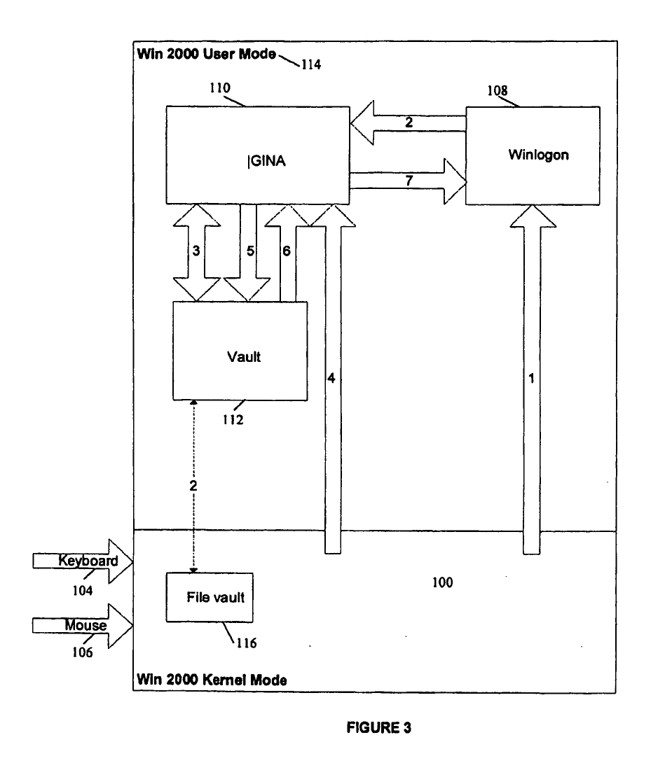

FIG. 3 is a schematic diagram of a file vault authentication system embodying the invention;

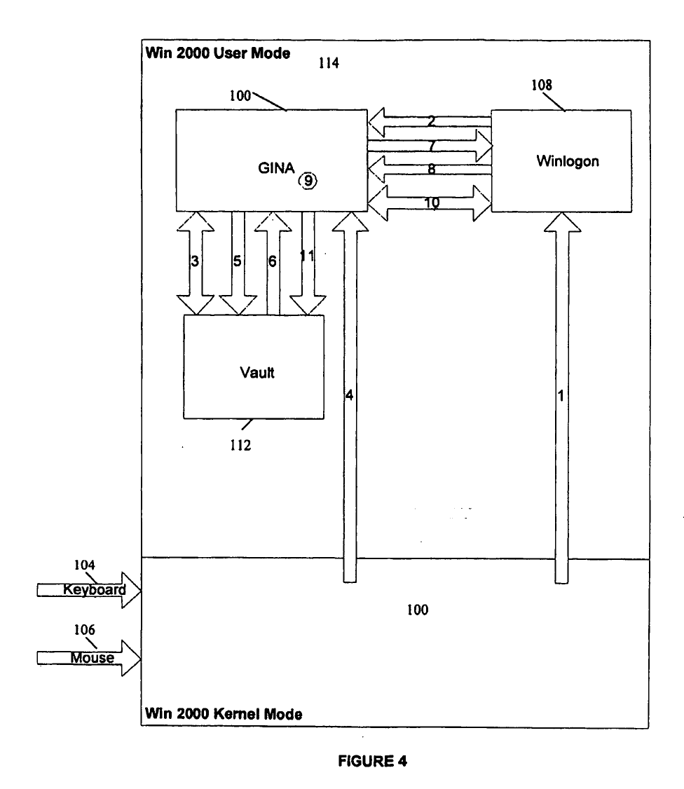

FIG. 4 shows the random renegotiation of passwords during authentication;

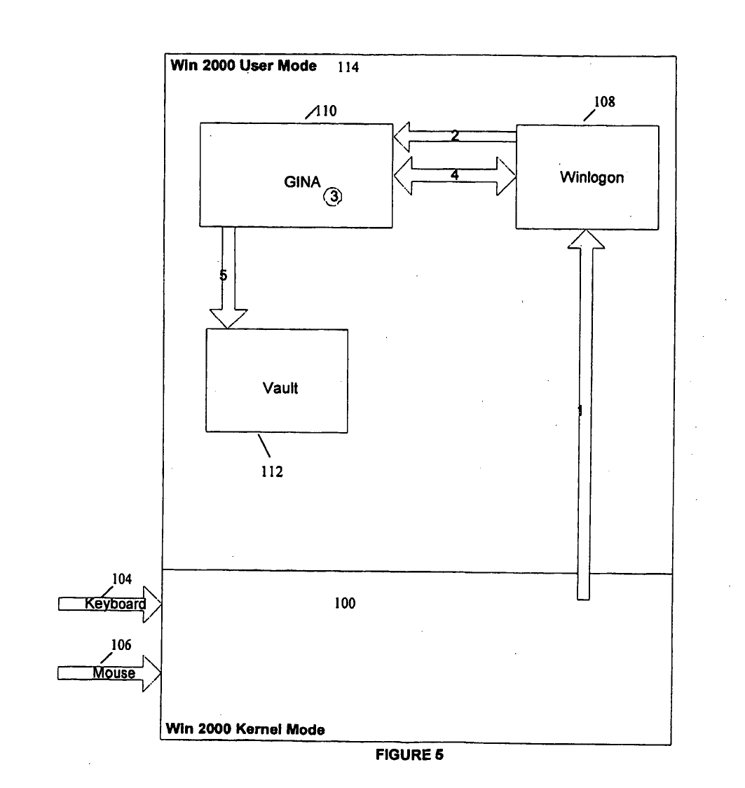

FIG. 5 shows end-user initiated random renegotiation of passwords;

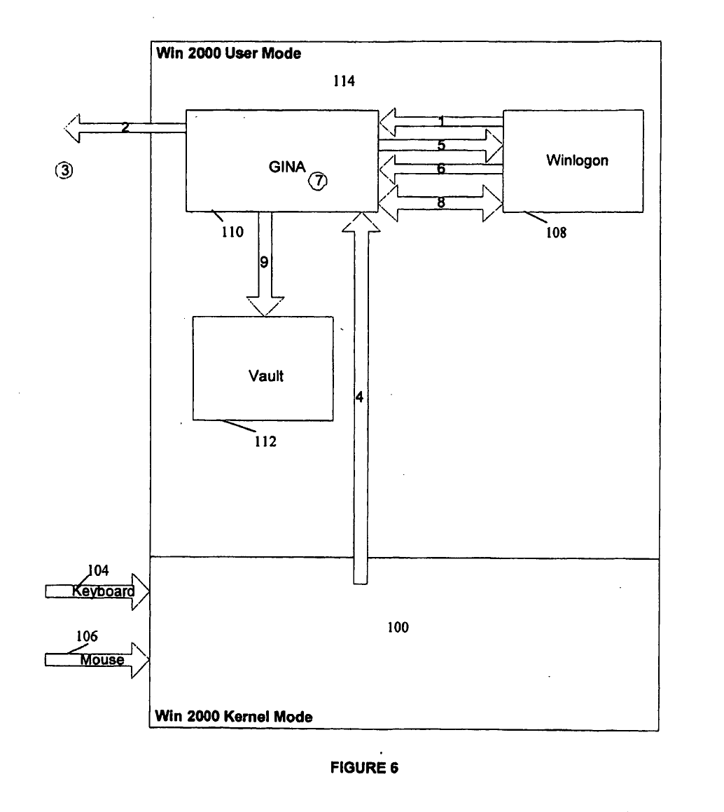

FIG. 6 shows how passwords may be recovered;

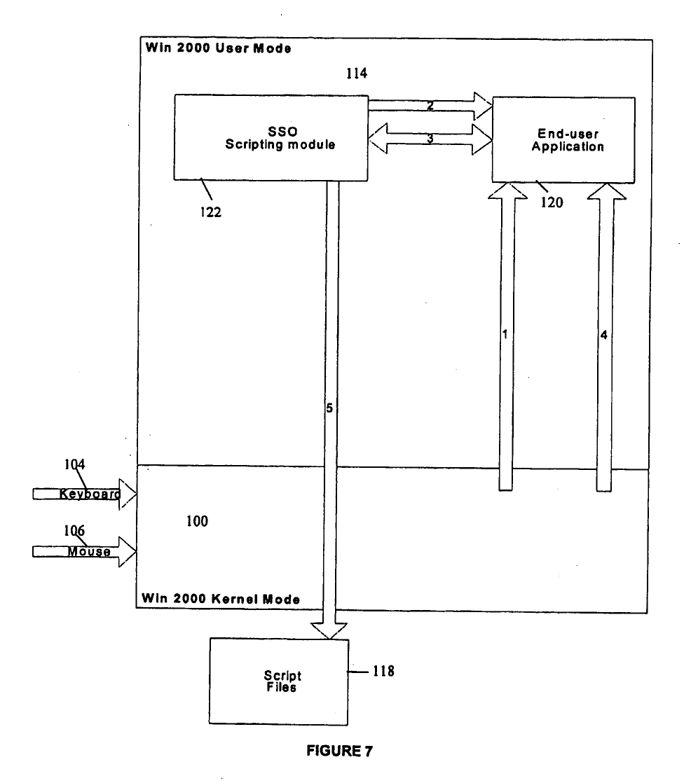

FIG. 7 shows how SSO script is created;

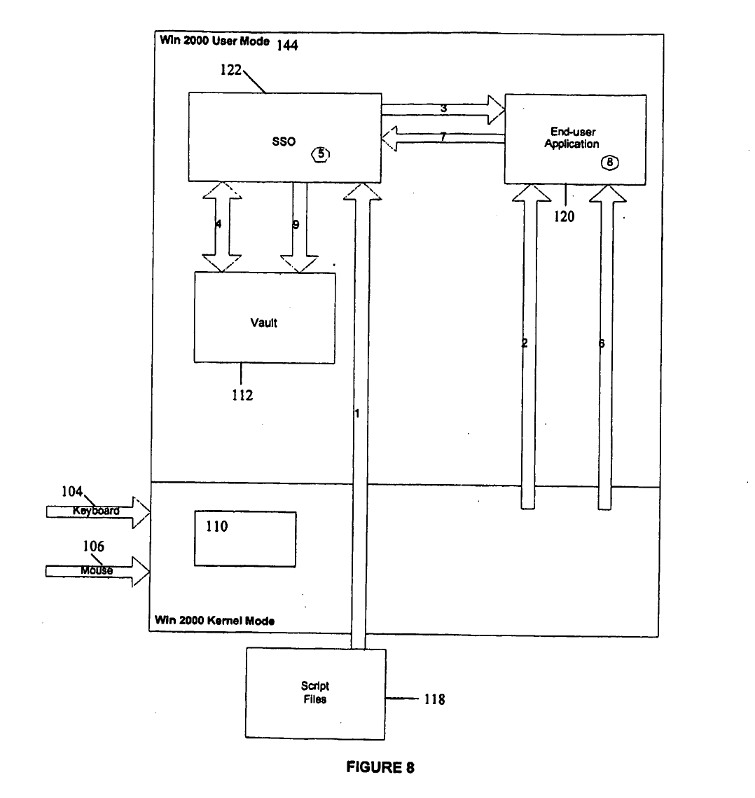

FIG. 8 shows how the SSO learns the credentials of an application;

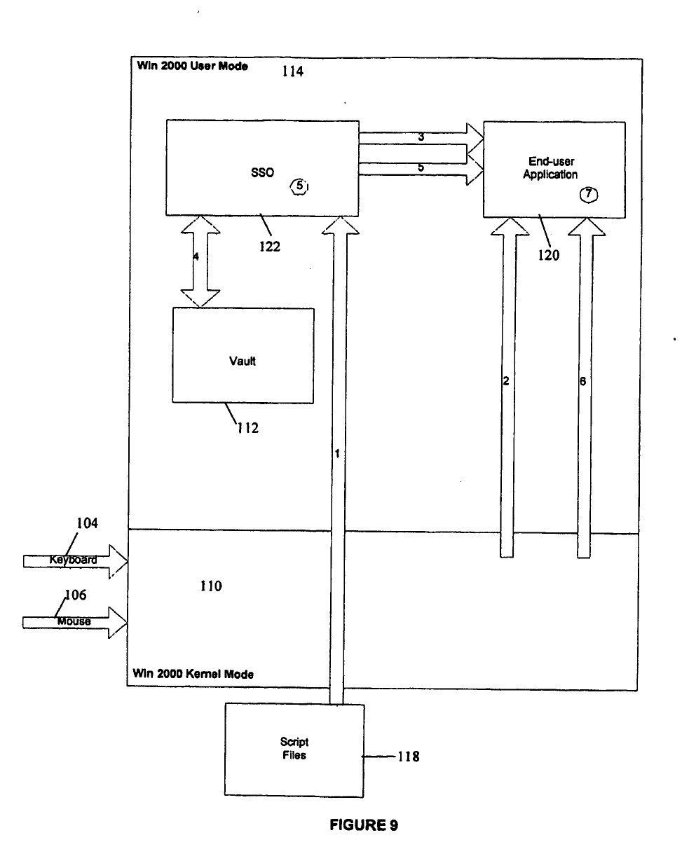

FIG. 9 shows how the SSO replays the credentials of an application;

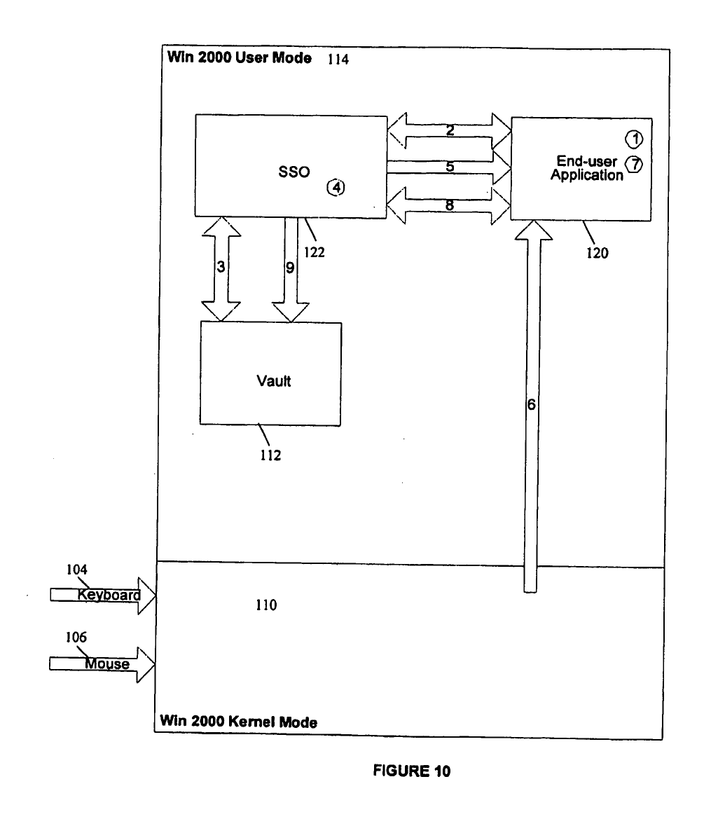

FIG. 10 shows how the SSO initiates random password change;

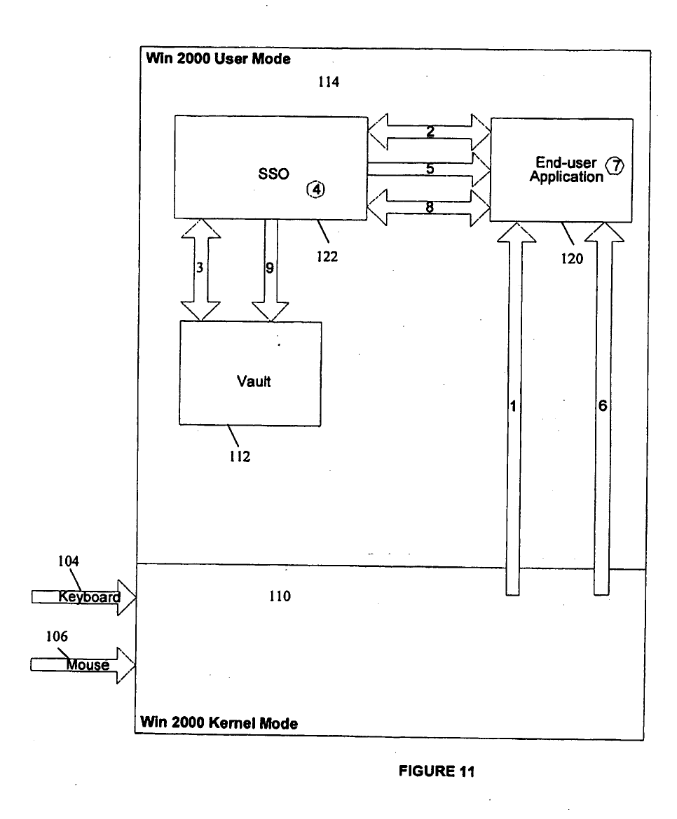

FIG. 11 shows SSO end-user initiated random password change;

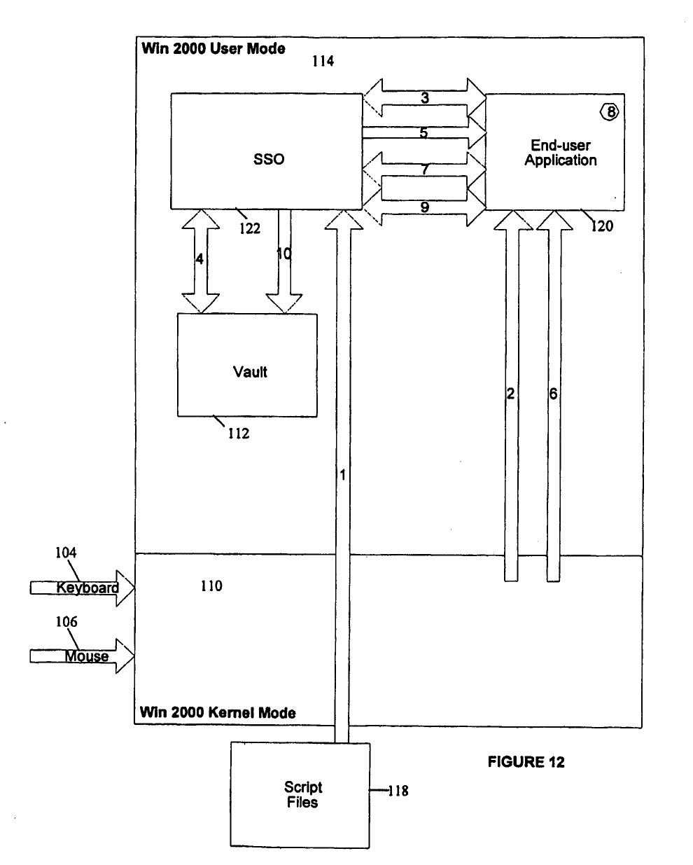

FIG. 12 shows the mechanism for SSO password recovery;

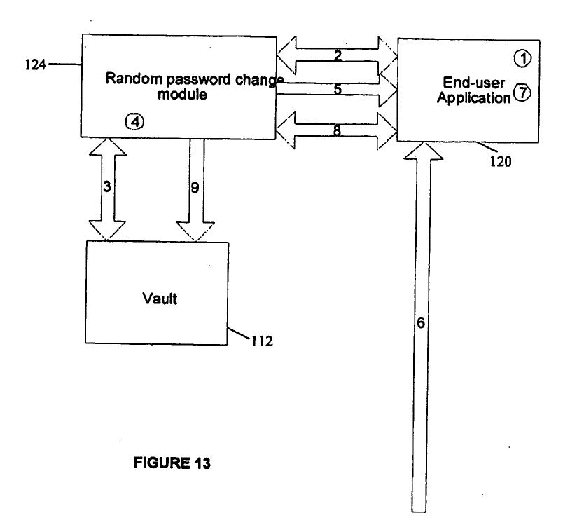

FIG. 13 shows generic system initiated random password change;

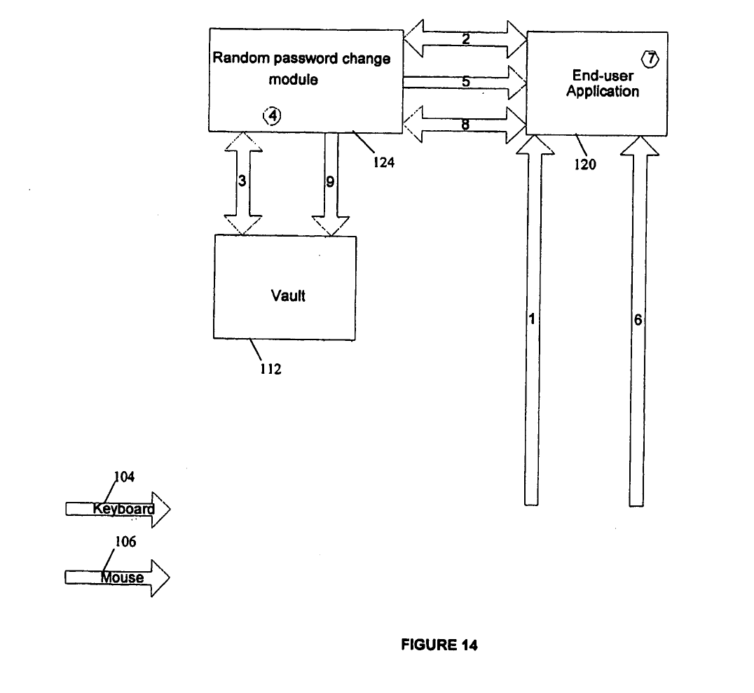

FIG. 14 shows generic end-user initiated random password change; and

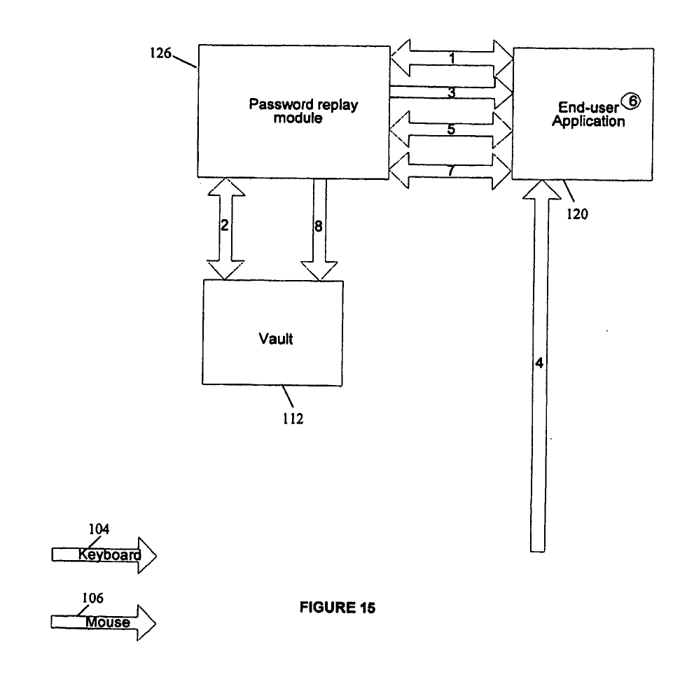

FIG. 15 shows generic password recovery.

A major problem, in terms of cost and security, with computer authentication systems is the tendency for users to write down their passwords, tell them to others, or forget them. The embodiments to be described use random passwords held on a secure storage means. Users do not know their own password, making the computer system more secure and making it impossible for keyboard sniffers to find out passwords. New random passwords are generated for the users when required by the authentication system, for example an authentication server. The users are unaware of the password generation. The authentication server is then updated with the new passwords. This may be done during a secure password change process that is inbuilt into the operating system.

The following description relates to an embodiment that is intended to be used as a system running a Microsoft Windows operating system such as Windows 2000™.

It should be understood that the invention is not limited to any particular operating system as the principles of the invention are applicable to any computer system running any operating system.

Windows 2000 includes a Graphical Identification and Authentication module (GINA). The GINA is the object code module that collects end-user credentials and then submits them to the operating system for authentication. The operating system is specifically designed to allow replacement of the GINA. The following description describes a replacement GINA together with secure storage for passwords.

When a user attempts to authenticate the Microsoft 2000 operating system, they are prompted for the location of their secure storage container. This may be a secured file or a smart card. They are then required to enter the PIN or pass phrase to gain access to their secure storage container. The system automatically retrieves the end-user credentials. These will include a name and password and, optionally, a domain. The credentials are submitted automatically to the operating systems authentication mechanism.

When the operating system authentication mechanism reports that the user has successfully authenticated, a new password is generated by the system. This is a random password which is submitted as a secure password change request to the operating system. When the password change request is successful, the end-users credentials are updated on the secure storage. The whole process is transparent to the end-user.

The operating system controls the instigation of the password change. The authentication module responds to the operating system requesting that the end-user change their password by generating a new random password and submitting this on the end-user's behalf. If the password change is accepted by the operating system, the new password is updated on the secure storage.

The requirement for an end-user to generate a new password is controlled by the operating system policy allowing the system administrator to control the number and amount of password change requests flowing across the network.

The secure storage can be realised in any convenient manner. For example it may be a soft store, such as a file system file vault or a hard store such as a smart card with secure PIN controlled access.

It will be appreciated that the random passwords generated may be very complex and may contain not only non-alphanumeric characters but also non keyboard characters, thus introducing a further degree of security.

FIG. 1 shows the flow of information in the process described above. In FIG. 1, an end-user PC 10 communicates across a network 20 with an authentication server 30. The end user PC 10 includes a secure storage 40 which may be a smart card or a secure file.

At step 50, the PC user attempts to initiate authentication. At step 52, the secure media or storage is selected and at 54 unlocked using the PIN. At 56 the user's authentication credentials are retrieved from the secure media.

At 58, the end-user PC 10 sends the authentication credentials across the network 20 to authentication server 30. The server 30 authenticates the user and sends a successful authentication response to the end user at 60.

This is followed by a password change message sent at 62 by the authentication server 30 to the user PC. At 64 a new random password is generated and at 66 this new password is sent securely to the server 30 by the operating system. The authentication server sends a message back to the end-user PC indicating that the password change has been accepted at 68. The new password is then stored on the secure media at 70. The entire password change process is wholly transparent to the user who merely enters the PIN and is unaware of either the new or old passwords stored on the secure media.

FIG. 2 shows, in more detail, the authentication process using a smart card vault as the secure medium. Windows 2000 kernel mode 100 accepts inputs from the smart card 102, the user PC keyboard 104 and mouse or other pointing device 106. The remaining operation involving Windows log-on 108 GINA 100 and the vault 112 are performed with the operating system in user mode 114.

At step 1, the user inserts their smart card 102 into a smart card reader (not shown). The GINA 110 is notified in step 2 via the Windows log-on procedure 108 that a smart card has been inserted. The GINA then locates the smart card and displays an “enter PIN” screen at the user's PC display at step 3. The user then enters their PIN at step 4 via the keyboard 104 or mouse 106. The PIN is passed to the GINA 110. At step 5, the GINA logs into the smart card vault using the PIN inserted by the user. The GINA extracts the end-user's authentication credentials from the vault at step 6 and returns those credentials to the operation system in the form of the Winlogon procedure 108 at step 7.

FIG. 3 shows the same authentication procedure where a file vault is used instead of a smart card. The same numbering is used as in FIG. 2 except that the file vault is referenced by the number 116.

To initiate the process, the user first wakes up the Winlogon procedure of the operating system at step 1. At step 2, Winlogon notifies the GINA 110 that a user is trying to log on to the system. The GINA 110 notifies the vault 112 at step 3 and displays the “enter” PIN screen to the user as in the previous example of FIG. 2. At step 4, the user enters their PIN via the keyboard 104 or mouse 106 and the PIN passes to the GINA.

The GINA then, at step 5, logs into the vault 112 using the PIN and retrieves the end user's authentication credentials from the vault at step 6. At step 7, the GINA 110 returns the authentication credentials to the Winlogon procedure 108 of the operating system.

FIG. 4 shows how the GINA performs random password renegotiation during authentication. At step 1, the user wakes up the Winlogon procedure or inserts a smart card or as described with respect to FIGS. 2 and 3. At step 2 the operating system informs the GINA 110 that an end-user is trying to authenticate. At step 3 the GINA locates the vault and displays the enter PIN screen to the end user. The PIN is entered by the user at step 4 and passed to the GINA, whereupon the GINA logs onto the vault 112 using that PIN. At steps 6 and 7 the GINA retrieves the end-user's credentials from the vault and passes them to the Winlogon procedure 108. When the user is successfully authenticated and if the user profile is set such that passwords should be changed each time the user logs on, using a “change password on next use” command in the user's operating system profile, Winlogon 108 notifies GINA 100 to change the user's password at step 8. GINA 110 generates a new random password, using any known password generation technique at step 9. One example, which is applicable to all embodiments of the invention to be described is to use a cryptographically correct random number generator and then mapping the resulting output onto the typeable character set. Other methods are possible and the invention is not limited to any particular method. At step 10, GINA 100 submits a password change request to the operating system and at step 11, the password change request is processed successfully by the operating system so that the GINA updates the end user's credentials stored in the vault 112 with the new password. It should be noted that the user is not aware of this new password.

FIG. 5 is a similar figure to FIG. 4, showing how a random password can be re-negotiated at the request of the end-user.

Steps 1 and 2 are the same as in the FIG. 4 example with the Winlogon procedure being woken up at step 1 and the GINA 110 being notified at step 2 with a password display screen being generated and sent to the user. This display includes an option to change the password. This option is selected by the user and at step 3 the GINA 110 generates a new random password for the end-user. This is submitted to the Winlogon procedure 108 in a password change request at step 4 and, when confirmation of the successful request is received by the GINA from Winlogon, the GINA updates the end-user's credentials in the vault by storing the new password. Again, the user, although having elected to change their password, is not aware of the identity of the new password.

FIG. 6 shows how a password may be recovered and is triggered when the end-user credentials recovered by the GINA from the vault are incorrect and the end-user is unable to authenticate the operating system.

At step 1, the operating system, through the Winlogon procedure 108, returns an error indicating that authentication credentials supplied, for example following the process described above with respect to FIGS. 2 and 3, are incorrect. At step 2, the GINA causes an error recovery screen to be displayed to the end-user. This screen gives the end-user the necessary information required to reset their credentials. At step 3, the end-user contacts the system administrator to obtain a single usage password which they then enter into the GINA 110 at step 4.

The GINA then submits the end-user's credentials including the single usage password to the operating system. The operating system then authenticates the end-user at step 6 and Winlogon 108 notifies the GINA to change the end-user's password. This occurs as the “change passwords on next use” option is set in the end-user's operation system profile as a consequence of obtaining the single usage password from the system administrator. The GINA then generates a new random password at step 7 and submits a password change request to the operating system at step 8. If this change request is processed successfully the GINA 110 is notified by Winlogon and the GINA then updates the vault 112 to store the newly generated password with the end-user's credentials. Again, the end-user is unaware of the new password.

FIGS. 7 to 12 show an enhancement of the system described above. In the previous description, a single password giving the user access to the system has been generated. In practice, the user will run many different applications on his PC once he has access. Many of these applications will have their own passwords. The form of password that is acceptable will vary from application to application. For example, there may be limits as to the minimum or maximum number of symbols in the password or to the symbols that may be used in the password. The embodiments of FIGS. 7 to 12 enable all passwords used by the end user to be generated automatically by the system and changed transparently to the user as described above.

FIG. 7 shows the creation of a single sign on SSO script.

At step 1, the end-user is navigated by the system administrator to get to a screen that is required to be learned. This may be a screen in an application 120 which asks for a password and a user name. The system must learn the layout of this screen including where user name and password information are to be inserted.

At step 2, the system administrator selects the end-user application screen using and SSO script creation tool which form a part of a scripting module 122. At step 3, the client application's authentication screens are fingerprinted so that the scripting module 122 can learn how the screens are constructed. When this has been completed, the system administrator tests the script or scripts at step 4 and, if they are found to function correctly, for example as the end-user is permitted access to the applications, the generated scripts are stored as script files 118 in a store for future distribution, when end-users want to access the application.

The system administrators will select the relevant script files 118 for distribution to end-users who may wish to run the application.

The files are then distributed by a client specific mechanism to target computers. When the application is next run by end-user, the scripting module 122 loads the SSO scripts from the script files, allowing access to the application without the user having to type in user name and password details themselves, but still retaining the advantage of password controlled access to the application.

FIG. 8 shows how the scripting module 122 can learn the credentials of an application. There are the credentials of an end-user used to gain access to the application.

At step 1, the SSO module loads the scripts from the script files store 118 when it is first run. The end-user then, at step 2, runs an application 120 for which a script has been loaded. The SSO module at step 3 detects the application authentication screen and, at step 4, queries the vault 112 which holds the end-user's credentials, for authentication credentials relevant to the that authentication screen. As the vault will not hold any authentication credentials relevant to that application in the vault, the SSO module 122 enters an automatic learning mode at step 5. At step 6, the end-user submits their authentication credentials to the application and at step 7, the SSO module 122 temporarily retrieves those credentials from the application authentication screen. The application then authenticates the user at step 8. This authentication is detected by the SSO module 122 at step 9. In response, the SSO module saves the end-user credentials to the vault. Thus, when the end-user subsequently accesses the application, the correct authentication details will be found in the vault at step 4 and the end-user will be authenticated without having to enter any authentication details themselves. This process is shown in FIG. 9. Steps 1 to 3 are the same as in the previous example. At step 4, the authentication credentials are found in the vault 112 and the SSO module enters an automatic reply mode. At step 5, the SSO module populates the end-user credentials into the application authentication screen and at step 9 this screen is submitted by the end-user whereupon the application successfully authenticates at step 7.

FIG. 10 shows how the SSO module 122 can generate a new random password following a password change request received from the application. This request is generated by the application at step 1 and a password change screen is generated. This screen is detected by the SSO module at step 2 and an automatic password renegotiation routine is entered at step 3 as authentication credentials are already stored in the vault 112. At step 4, the SSO module generates a new random password and at step 5 submits the old authentication credentials together with the new random password to the end-user application password change screen. This is typically required by many applications which require both an old and a new password to be entered into the screen for a password to be changed. The password change screen is then submitted by the end-user at step 6 and the password changed at step 7. This change is detected by the SSO module at step 8 and the new password is saved to the vault 112 at step 9.

FIG. 11 shows how an end-user initiated password change may be effected. At step 1 the user selects the password change option in the application. In the remaining steps the SSO module will generate and store a new random password and submit this password to the application. At step 2, the password change screen is detected by the SSO module and, as there are authentication credentials in the vault, an automatic password renegotiation mode is entered at step 3. The remaining steps 4 to 9 are then the same as steps 4 to 9 described in relation to FIG. 10 above.

FIG. 12 shows the process for SSO password recovering. This process is triggered if the end-user credentials retrieved from the vault, which may be a smart card or a file, are incorrect for the application so that authentication is not possible.

At step 1, the SSO loads the scripts files 118 when it is first run. Some time later, at step 2, an end-user runs an application for which a script has been loaded. The SSO module detects the application authentication screen at step 3. At this stage the module 122 will find authentication credentials in the vault. It therefore enters the automatic replay mode at step 4. The end-user's credentials are populated into the application authentication screen by the SSO module at step 5 but, at step 6, the end-user overtypes the authentication credentials with the correct details and submits the modified screen to the application. At step 6, the SSO module detects the modifications to the authentication credentials and makes a temporary copy. Once the application has successfully authenticated at step 8, the SSO module detects the authentication at step 9 and saves the new applications that have been temporarily stored, in the vault 112.

FIG. 13 shows a generalisation of the GINA and SSO password changes that have been described in FIGS. 4 and 10. At step 1, an application prompts the end-user to change their password. The password change screen is automatically detected at step 2 and the vault 112 checked for authentication credentials at step 3. If these credentials are present, an automatic password renegotiation mode is entered. First at step 4, the random password module 124, which could be part of the GINA or the SSO module 122 or some other entity, generates a new random password at step 4. At step 5, this new password is submitted with the old authentication credentials to the end-user application password change screen. At step 6, the end-user submits the password change screen and at step 7 the application successfully changes the password. This change is detected at step 9 and the new password is saved to the vault as part of the end-user authentication credentials.

FIG. 14 shows a generic end-user initiated random password change. As with FIG. 13 above, this could be performed by the GINA or by the SSO module or otherwise and is independent of any particular operating system. The steps in the process are the same as the FIG. 13 process except that the initial step is a user selected password change screen rather than a password change screen generated by the application at the application's instigation.

FIG. 15 is a generic view of the password recovery process which, as in the previous two examples, is independent of any particular operating system and could be performed by the GINA to SSO module or some other routine. When an authentication screen is detected at step 1 the password replay module 126 checks the vault 112 for authentication credentials. If they are found, at step 2, the module 126 enters an automatic replay mode. At step 3, the end-users credentials are read from the vault by module 126 and populated into the authentication screen. Following an authentication failure returned by the application, the end-user overtypes the correct authentication credentials via keyboard input 104 and submits the authentication screen at step 4. The password replay module 126 makes a temporary copy of the authentication credentials at step 5. The application then successfully authenticates at step 6, and, at step 7, this authentication is detected by module 126 and, at step 6, the new credentials are saved to the vault.

In the embodiments described, the SSO and GINA are completely separate applications. However, both may use common modules which may be, for example, implemented in MAITRICS.

The vault architecture may also be implemented in MAITRICS. The vault architecture stores credentials for many applications including GINA. SSO uses the same architecture to store and manage passwords for other desktop applications.

It will be appreciated that embodiments of the invention have many advantages. For example, security of computer systems can be enhanced without users having to remember complex and difficult passwords. The user may only have to remember a simple password or a PIN and the system can generate a more complex password that is unknown to the user. Moreover, this password may be changed in a process which is transparent to the user, for example every time the user logs onto the system.

As well as providing improved security, the method and system described may be used to authenticate the user to various applications run on the users PC. The authentication of these applications is performed automatically as is password change. This has the advantage of maintaining security while making the applications easy to access by the user and avoiding the need for the user to remember many different passwords.

Various modifications to the embodiments described are possible and will occur to those skilled in the art without departing from the scope of the invention. For example, the system and method described may be used with operating systems other than Windows 2000, for example Windows XP, Windows NT, other Microsoft operating system and operating system provided by other parties.

The scope of the invention is defined solely by the following claims.

1. A method of authenticating a computer user comprising unlocking a secure media using a user entered identification, retrieving authentication credentials for the user from the secure media, the authentication credentials including a password, verifying the authentication credentials and, on successful verification, authenticating the user.

2. A method according to claim 1, wherein the retrieval of authentication credentials comprises retrieving the credentials from a vault.

3. A method according to claim 2, wherein the vault is located on the secure media.

4. A method according to claim 3, wherein the secure media is a smart card.

5. A method according to claim 2, wherein the vault is a secure file.

6. A method according to claim 1 comprising changing the password stored as part of the authentication credentials on the secure media without disclosing the new password to the user.

7. A method according to claim 6, wherein changing the password comprises generating a random password in response to a change password request, authenticating the new password and storing the new password on the secure media, when authenticated as part of the user's authentication credentials.

8. A method according to claim 6, wherein the password is changed in response to a request generated by the computer operating system or an application running on the computer.

9. A method according to claim 7, wherein the change password request is generated by the user.

10. A method according to claim 1 comprising running a password recovery process if the authentication credentials are not verified, the password recovery process comprising assigning a one-time password to the user, submitting the authentication credentials including the assigned one time password, authenticating the user, generating a change password request, generating a new password in response to the change password request, and updating the secure media with the new password.

11. A method according to claim 10, wherein the new password is a random password.

12. A method according to claim 1, wherein the authentication permits user access to a computer system, wherein secure media is unlocked by the system graphical identification and authentication module (GINA) an the authentication credentials are retrieved by the GINA from the secure media and passed to the computer operating system for verification as part of the operating system logon procedure.

13. A method according to claim 12, comprising changing the password stored as part of the authentication credentials on the secure media without disclosing the new password to the user, wherein changing the password comprises generating a random password in response to a change password request, authenticating the new password and storing the new password on the secure media, when authenticated as part of the user's authentication credentials, and wherein the new random password is generated by the GINA and sent by the GINA to the operating system logon procedure, and, when authenticated, the GINA causes the new random password to be stored in the secure media.

14. A method according to claim 13, wherein the new password is generated by the GINA and authenticated by the computer operating system.

15. A method according to claim 1, wherein the authentication permits user access to an application running on a computer system comprising generating scripts corresponding to application authentication requests.

16. A method according to claim 15, wherein the script generation comprises navigating the application to an authentication screen, selecting the authentication screen, generating a script corresponding to the application screen, testing the generated script and saving the script.

17. A method according to claim 15, comprising distributing the script to one or more users of the application to which it relates.

18. A method according to claim 17 comprising loading the script at a computer to which the script has been distributed.

19. A method according to claim 15, comprising learning user credentials for the application, the user credentials including a password.

20. A method according to claim 19, wherein the learning of user credentials comprises running the generated script, detecting an application authentication screen, querying the secure media for authentication credentials for the application, reading authentication credentials submitted by the user if no credentials are found for the application on the secure media, retrieving the submitted credentials from the screen and, on authentication of the end user, saving the credentials at the secure media.

21. A method according to claim 20, comprising replaying the stored authentication credentials on subsequent attempts to open the application by the user.

22. A method according to claim 21, wherein the replaying of user credentials comprises detecting the application authentication screen, retrieving the authentication credentials from the secure media, populating the authentication screen with the authentication credentials and submitting the authentication screen to the application.

23. A method according to claim 15, comprising detecting a password change screen relating to the application, generating a new random password, submitting the new password to the application, and, on detection of completion of the password change, storing the new password at the secure media.

24. A method according to claim 23, wherein the new password is submitted to the application with the old password.

25. A method according to claim 15, comprising displaying an application authentication screen to the user when authentication credentials retrieved from the secure media are rejected by the application, receiving correct authentication credentials from the user, submitting the authentication screen with the correct authentication credentials to the application, and on authentication, storing the correct credentials in the secure media.

26. A method according to claim 25, comprising temporarily storing the correct authentication credentials when the credentials are submitted to the application.

27. A computer readable storage medium having stored thereon computer readable code which when run on a computer causes the computer to perform the steps of authenticating a computer user comprising unlocking a secure media using a user entered identification, retrieving authentication credentials for the user from the secure media, the authentication credentials including a password, verifying the authentication credentials and, on successful verification, authenticating the user.

28. A computer or computer network programmed to perform the steps of authenticating a computer user comprising unlocking a secure media using a user entered identification, retrieving authentication credentials for the user from the secure media, the authentication credentials including a password, verifying the authentication credentials and, on successful verification, authenticating the user.

29. Apparatus for authenticating a computer user comprising a secure media having user authentication credentials including a password stored therein, means for unlocking the secure media via a user entered identification and retrieving the credentials and means for verifying the credentials and, on verification, authenticating the user.

30. Apparatus according to claim 29, wherein the secure media includes a vault for storing the authentication credentials.

31. Apparatus according to claim 30, wherein the secure media is a smart card and the means for unlocking the secure media includes a smart card reader.

32. Apparatus according to claim 30, wherein the vault comprises a secure file.

33. Apparatus according to claim 29, where the means for unlocking the secure media further comprises means for changing the user password without disclosing the new password to the user.

34. Apparatus according to claim 33, wherein the means for changing the password includes a random password generator responsive to a change password request, and where the means for including the secure media comprises means for storing the new password in the secure media on authentication of the new password.

35. Apparatus according to claim 29 wherein the authentication permits user access to a computer system, and the means for unlocking the secure media comprises a Graphical Identification and Authentication Module (GINA) arranged to retrieve authentication credentials from the secure media and pass them to the operating system of the computer system for verification as part of the operating 15 system logon procedure.

36. Apparatus according to claim 35, wherein the GINA includes the random password generator, means for sending the newly generated password to the operating system for authentication, means for temporarily storing the new password and means for causing the new password to be stored in the secure media on verification by the operating system.

37. Apparatus according to claim 29, wherein the authentication permits user access to an application on a computer system, comprising a script generator for generating scripts corresponding to application requests.

38. Apparatus according to claim 37, wherein the script generator comprises means for navigating the application to an authentication screen, means for selecting the authentication screen, means for generating a script corresponding to the authentication screen, means for testing the generated script and a store for storing the script.

39. Apparatus according to claim 37, comprising means for distributing the script to one or more computers using the applications to which the script relates.

40. Apparatus according to claim 39, comprising means at a computer to which the script is distributed for loading the script.

41. Apparatus according to claim 37, comprising a scripting module including means for learning user credentials for an application including a password.

42. Apparatus according to claim 41, wherein the learning means comprises means for running the loaded script, means for detecting an application authentication screen, means for querying the secure media for authentication credentials for the application, means for reading authentication credentials submitted by the user if no credentials are found at the secure media, means for retrieving the submitted credentials and means for saving the credentials at the secure media.

43. Apparatus according to claim 42, comprising means for replaying the stored authentication credentials on subsequent attempts to open the application by the user.

44. Apparatus according to claim 37 comprising a temporary store for new passwords prior to authentication and storage in the secure media.

45. A computer including apparatus according to claim 29 for authenticating a user to the computer of an application running on the computer.

46. A computer network including apparatus according to claim 29 for authenticating a user to the network or to an application running on the network.

47. Apparatus for authenticating a user to a computer network comprising a secure media at a network computer, the secure media storing authentication credentials including a password stored therein, a GINA program for unlocking the secure media in response to a user PIN, the GINA further comprising code for retrieving the authentication credentials from the secure media and passing them to the computer or network operating system for verification.

48. Apparatus according to claim 47, wherein the GINA further includes code for detecting a password change request from the operating system, for generating a new random password in response to the request, for passing the new password to the operating system and, on authentication of the new password, storing the new password in the secure media as part of the authentication credentials.

49. Apparatus for authenticating a user of an application running on a computer or a computer network, comprising a secure media at the computer or a user computer on the network, the secure media storing authentication credentials including a password stored therein, a scripting module for unlocking the secure module in response to a user PIN, the scripting module further comprising code for retrieving the authentication credentials from the secure media and passing them to the application for verification.

50. Apparatus according to claim 49, wherein the scripting module includes code for detecting a password change screen generated by the application, code for generating a new random password in response to the screen, code for passing the new password to the application and, on authentication of the new password, code for causing the storage media to store the new password as part of the authentication credentials.
